(19) United States
(12) Patent Application Publication
(10) Pub. No.: US 2023/0127907 A1
(43) Pub. Date: Apr. 27, 2023

(54) INTENTION IDENTIFICATION IN DIALOGUE SYSTEM

(71) Applicant: INTERNATIONAL BUSINESS MACHINES CORPORATION, ARMONK, NY (US)

(72) Inventors: Zhong Fang Yuan, Xi'an (CN); Tong Liu, Xi'an (CN); Li Juan Gao, Xi'an (CN); Yi Chen Zhong, Shanghai (CN); Hai Bo Zou, Beijing (CN)

(21) Appl. No.: 17/451,836

(22) Filed: Oct. 22, 2021

(51) Int. Cl. G06F 40/35; G06F 40/295; G06N 5/00

(52) U.S. Cl. CPC G06F 40/35; G06F 40/295; G06N 5/003

(57) ABSTRACT

Embodiments of the present disclosure relate to question answering. A computer-implemented method includes determining a plurality of intention candidates of a user from the user's question; determining a set of entities and attributes associated with the set of entities from the plurality of intention candidates; constructing a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes; and generating a question corresponding to a node of the decision tree to determine the user's intention.

### BACKGROUND

The present disclosure relates to data processing, and more specifically to conducting a natural language dialogue between a dialogue system and a user of a client computing device.

A dialogue system is a computer system intended to converse with a human. Dialog systems have employed text, speech, graphics, haptics, gestures, and other modes for communication on both the input and output channel. In speech or text-based dialogue systems, such as automated customer service systems, users communicate with the system through spoken utterances or short text messages. Once a user input (spoken utterance or text input) is received, the automated system attempts to process/analyze the user utterance to reduce it to a computer understandable form. Given this unambiguous interpretation of the utterance, the system can perform tasks or produce a response, such as an answer to a question asked by the user. However, some user utterances, text inputs, or portions thereof, may be ambiguous to the dialogue system. For example, the user's question is “How to withdraw my pension?” The user may intend to withdraw pension in location A but the user's intention may be interpreted by mistake as how to withdraw pension in location B. As a result, the correct answer to the user's question is not accurately recalled and recommended.

### BRIEF SUMMARY

Additional aspects and/or advantages will be set forth in part in the description which follows and, in part, will be apparent from the description, or may be learned by practice of the invention.

According to one embodiment of the present disclosure, there is provided a computer-implemented method. A computer-implemented method for conducting a natural language dialogue between a dialogue system and a user of a client computing device, comprising receiving, by the one or more processing units, a user question from a client computing device. Determining, by one or more processing units, a set of entities and attributes associated with the set of entities from the plurality of intention candidates. Constructing, by one or more processing units, a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes. Generating, by one or more processing units, a question corresponding to a node of the decision tree to determine the user's intention. Transmitting, by the one or more processing units, the question to the client computing device. Receiving, by one or more processing units, the user's answer to the question from the client computing device. Determining, by one or more processing units, the user's intention from the decision tree based on the user's answer to the question. Determining and transmitting, by one or more processing units, a response to the user's question based on the user's intention.

According to another embodiment of the present disclosure, there is provided a device. The device comprises a processor; and a memory having instructions stored thereon for execution by the processor, the instructions, when executed by the processor, cause the device to perform acts for conducting a natural language dialogue between a dialogue system and a user of a client computing device, the acts comprising. Receiving a user question from a client computing device. Determining a plurality of intention candidates of a user from the user's question; determining a set of entities and attributes associated with the set of entities from the plurality of intention candidates; constructing a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes; and generating a question corresponding to a node of the decision tree to determine the user's intention. Transmitting the question to the client computing device and receiving the user's answer to the question from the client computing device. Determining the user's intention from the decision tree based on the user's answer to the question. Determining and transmitting a response to the user's question based on the user's intention.

According to another embodiment of the present disclosure, there is provided and comprising machine-executable instructions, the instructions, when executed on a device, causing the device to perform acts for conducting a natural language dialogue between a dialogue system and a user of a client computing device, the acts comprising. Receiving a user question from a client computing device. Determining a plurality of intention candidates of a user from the user's question; determining a set of entities and attributes associated with the set of entities from the plurality of intention candidates; constructing a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes; and generating a question corresponding to a node of the decision tree to determine the user's intention. Transmitting the question to the client computing device and receiving the user's answer to the question from the client computing device. Determining the user's intention from the decision tree based on the user's answer to the question. Determining and transmitting a response to the user's question based on the user's intention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts a flowchart of a method for conducting a natural language dialogue according to some embodiments of the present disclosure.

FIG. 5 depicts a method for obtaining an intention set according to some embodiments of the present disclosure.

FIG. 6 depicts an example intention set according to some embodiments of the present disclosure.

FIG. 7 depicts an example vocabulary according to some embodiments of the present disclosure.

FIG. 8 depicts an example decision tree according to some embodiment of the present disclosure.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

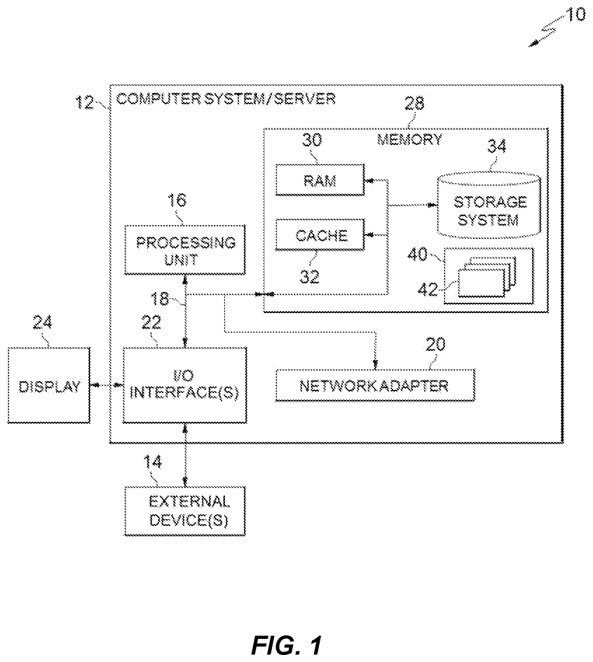

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

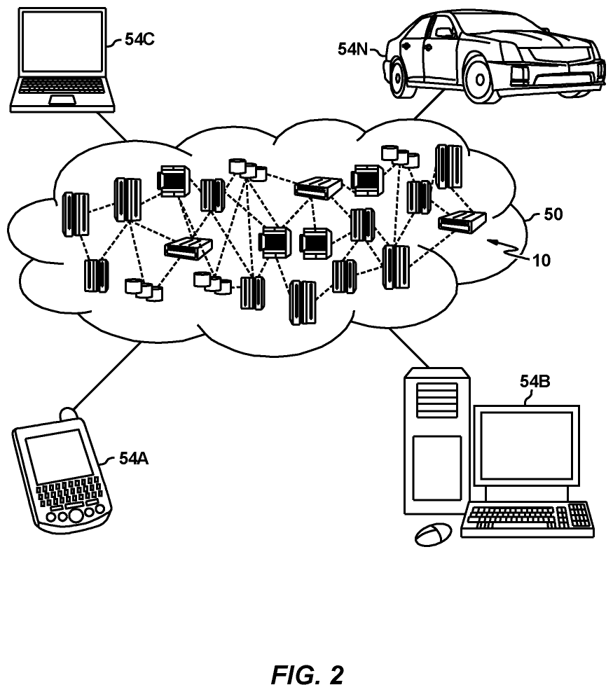

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

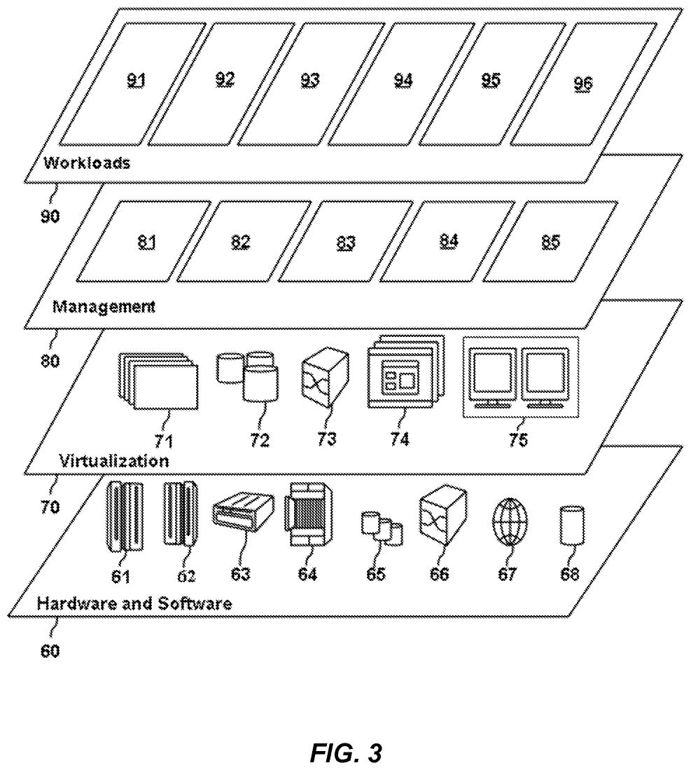

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and question answering (QA) 96.

The present embodiments provide mechanisms for determining an intention of a user. An intention is a purpose/goal/reason behind an utterance, either textual or audible, exchanged with a dialogue system. The first thing you need to do when you get the utterance from the user, is to understand what the user wants, and this is the intention classification or intention detection. For example, an intention may express whether the user wants the dialogue system to check the value of some variable against some reference amount or retrieve the amount of a variable or explain a variable. As noted above, in dialogue systems, some user speech utterances, text input, or portions thereof, may be ambiguous to the dialogue system and may reduce the accuracy of the generated responses, leading to user frustration. Determining a likely intention of a user, e.g., complaining about a bill, questioning a rate increase, etc., may assist in resolving such ambiguities. Therefore, intention detection in a dialogue system is a decisive step to drive the conversation in a dialog system in the right direction. It would be beneficial to have a mechanism for determining the likely intention of the user in a dialogue system.

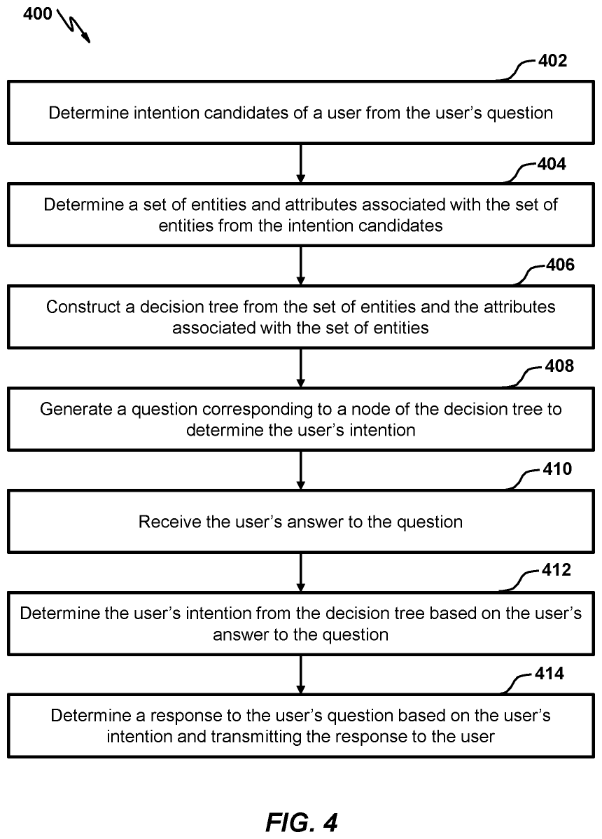

With reference now to FIG. 4, a method 400 conducting a natural language dialogue between a dialogue system and a user of a client computing device in accordance with some embodiments of the present disclosure is shown. A user may ask a question in a natural language form through the client computing device to expect an answer to that question from the dialogue system. For example, the user's question may be a speech input in a natural language form or a keyboard input. For example, the user may ask a question such as “How can I withdraw my fund?” The question may be ambiguous with respect to defining the user's intention. For example, the user may intend to withdraw his pension in the city of Beijing, rather than housing fund in the city of Xi'an. But the user's question does not specify the particular city and/or particular kind of fund in the question.

At block 402, the method 400 may determine a plurality of intention candidates for the user from the user's question. For example, one or more models may be configured to determine the user's intention candidates from the user's question. Each of the models may be a machine learning model for natural language processing. The machine learning model may be a text classification model, for example, a neural network. Each model may determine one or more intention candidates from the user's question, where the intention candidates may each have a higher probability than a predefined threshold. The probability may be the probability of being determined as true intention. Alternatively, some of candidates in a group of invention candidates may be of higher probability than the others in the group. Each model may determine a predefined number of intention candidates from the user's question that may have higher probability than the others. For example, each model may generate the top-5 results as the intention candidates.

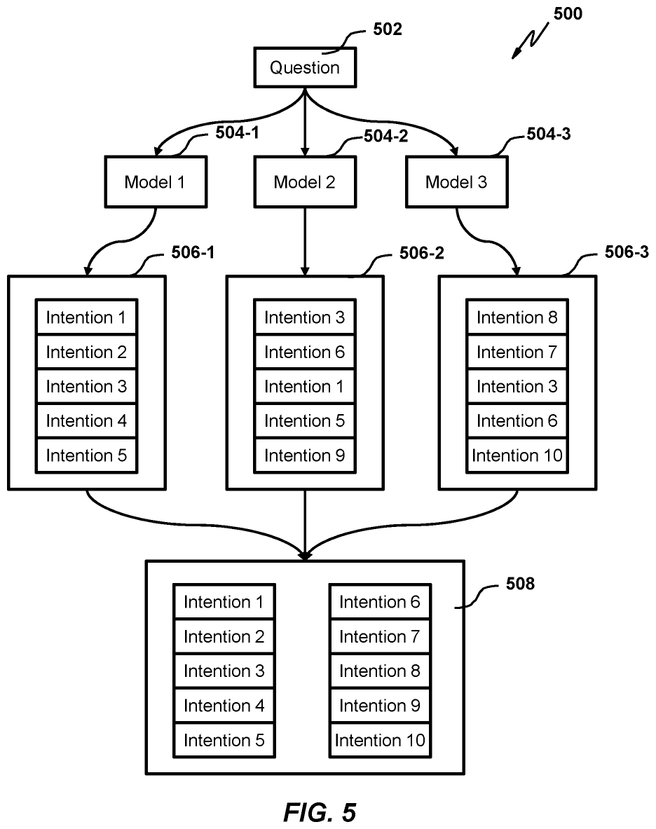

FIG. 5 is a schematic diagram illustrating a method 500 for obtaining an intention set including a plurality of intention candidates in accordance with some embodiments. As shown in FIG. 5, the user's question 502 is provided to each of models 504-1, 504-2, and 504-3 (collectively referred to as models 504). The models 504-1, 504-2, and 504-3 may determine respective intention candidates 506-1, 506-2, and 506-3 (collectively referred to as intention candidates 506) from the user's question 502. For example, the model 504-1 may determine the intention candidates 506-1 from the question 502. The intention candidates 506-1 include intentions 1 to 5, which are the top-5 results of the model 504-1 from the highest probability to the lowest probability. The model 504-2 may determine the intention candidates 506-2 from the question 502. The intention candidates 506-2 include intentions 3, 6, 1, 5, and 9, which are the top-5 results of the model 504-2 from the highest probability to the lowest probability. The model 504-3 may determine the intention candidates 506-3 from the question 502. The intention candidates 506-3 include intentions 8, 7, 3, 6, and 10, which are the top-5 results of the model 504-3 from the highest probability to the lowest probability.

As shown in FIG. 5, the intention candidates 506 may be merged or aggregated to obtain a group of intention candidates. The group of intention candidates may be deduplicated to obtain an intention set 508. The intention set 508 may include only one instance for each intention candidate. In this way, the number of intention candidates in the intention set 508 may be different from the total number of the intention candidates 506. For example, the intention candidates 506 include three instances of Intention 3 while the intention set 508 includes only one instance of Intention 3. The number of intention candidates in the intention set 508 is ten (10) while the total number of the intention candidates 506 is fifteen (15).

The intention candidates 506 have a relatively high probability but not the maximum probability to ensure a high recall rate. Recall rate, also known as recall, is the fraction of relevant instances that were retrieved and is the measure for how many true positives get predicted out of all the positives in the dataset. In this case, the intention candidates 506 may be referred to as recall intention candidate. The user's intention may be selected from the intention set 508 to disambiguate the user's question. By including the recall intention candidates, the intention set 508 may ensure or guarantee a high recall rate for intention classification, especially when more than one model is used for determining the intention candidates.

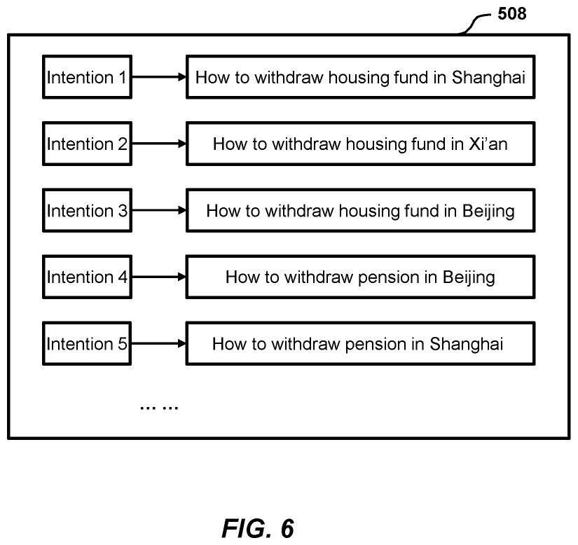

FIG. 6 shows an example of the intention set 508 in accordance with some embodiments of the present disclosure. For example, Intention 1 may be “How to withdraw housing fund in Shanghai”, Intention 2 may be “How to withdraw housing fund in Xi'an”, Intention 3 may be “How to withdraw housing fund in Beijing”, Intention 4 may be “How to withdraw pension in Beijing”, Intention 5 may be “How to withdraw pension in Shanghai”, and so on. For ease of discussion, reference is made to Intentions 1 to 5 in the following description.

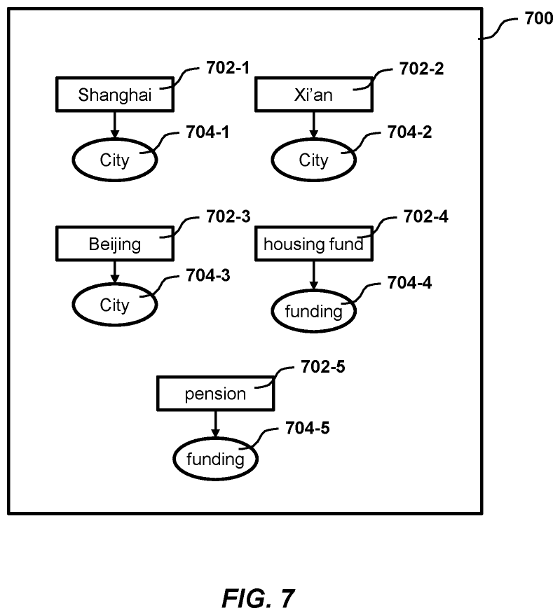

Returning to FIG. 4, at block 404, the method 400 may determine a set of entities and attributes associated with the set of entities from the plurality of intention candidates. An entity is an object in the real world with an independent existence that can be differentiated from other objects. For example, an entity may be a named entity. A named entity is a real-world object that can be denoted with a proper name. For example, the intention candidates may be segmented to obtain a lexicon or vocabulary of the user's intention. The lexicon or vocabulary may include the entities and associated attributes. The entities associated with an attribute may be the values of the attribute. The attributes may also be referred to as tags of the entities. In some embodiments, Named Entity Recognition (NER) may be applied to the intention set 508 to obtain the vocabulary of the user's intention, as depicted in FIG. 7. For example, the entity recognition may use Bidirectional Long Short-Term Memory—Conditional Random Field (BiLSTM-CRF).

FIG. 7 shows an example vocabulary 700 in accordance with some embodiments of the present disclosure. The vocabulary 700 includes a set of entities 702-1, 702-2, 702-3, 702-4, and 702-5 (collectively referred to as entities 702) and attributes 704-1, 704-2, 704-3, 704-4, and 704-5 (collectively referred to as attributes 704) associated with the set of entities 702-1, 702-2, 702-3, 702-4, and 702-5, respectively. The entity 702-1 is “Shanghai” and its attribute 704-1 is “City”; the entity 702-2 is “Xi'an” and its attribute 704-2 is “City”; the entity 702-3 is “Beijing” and its attribute 704-3 is “City”; the entity 702-4 is “housing fund” and its attribute 704-4 is “funding”; and the entity 702-5 is “pension” and its attribute 704-5 is “funding”.

At block 406, the method 400 may construct a decision tree from the set of entities and the attributes associated with the set of entities. Each node of the decision tree is associated with a respective one of the attributes and represents a respective subset of the plurality of intention candidates. For example, a root node of the decision tree may represent all of the plurality of intention candidates. The respective subset of the plurality of intention candidates may be split based on the entities associated with the respective one of the attributes. The intention candidates are examples for training to construct the decision tree. For example, the decision tree may be constructed from the vocabulary 700 by any training method currently known or to be developed in the future.

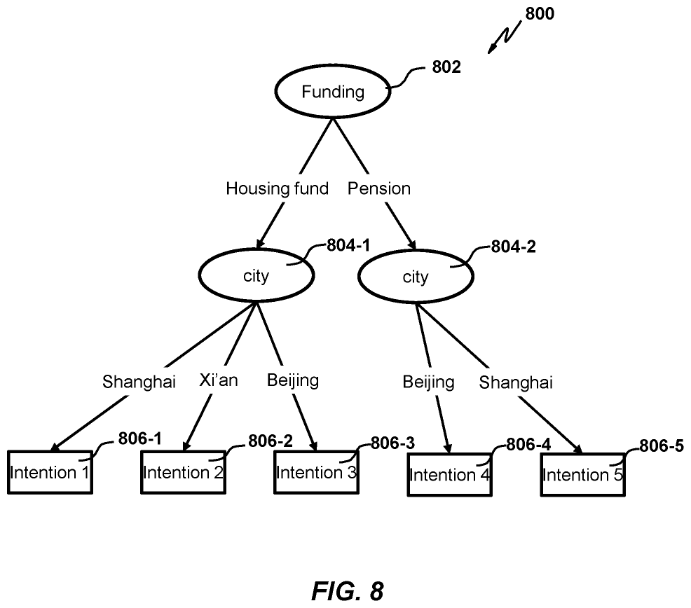

In some embodiments, the decision tree may be constructed from top to bottom. The “best” attribute may be first identified or selected to construct the root node of the decision tree. Information gain is an example of the information metric to select an attribute. In this instance, the “best” attribute is the attribute that has the highest information gain. Alternative information metrics may include information gain ratio, Gini index, Chi-square statistic, or the like. Then, the training examples may be partitioned based on the values of the attribute represented by the root node. The values of the attribute may be the entities associated with the attribute. An example method for constructing a decision tree will be described below with reference to FIG. 8. The method may be recursively applied to each partition to construct the decision tree. For example, the example algorithms for training the decision tree may be Top-Down Induction of Decision Trees (TDIDD), including ID3, C4.5 or the like.

FIG. 8 illustrates an example decision tree 800 in accordance with some embodiments of the present disclosure. The decision tree 800 includes a root node 802 and leaf nodes 804-1 and 804-2, where the leaf nodes 804-1 and 804-2 are child nodes of the root node 802. The root node 802 represents the attribute of “funding” which has the highest information gain. The root node 802 may represent all of the intention candidates which may be split based on the entities associated with the attribute of “funding”. The values of the attribute represented by the root node 802 may include housing fund and pension. In other words, the entities associated with the attribute of “funding” are housing fund and pension. The intention candidates may be partitioned based on the entities associated with the attribute represented by the root node 802 or the values of the attribute represented by the root node 802. For example, the first subset corresponds to housing fund and the second subset corresponds to pension. The “best” attribute for the first subset is selected to be “city” represented by the node 804-1, while the “best” attribute for the second subset is also selected to be “city” represented by the node 804-2. Further, the respective subset of the plurality of intention candidates may be split based on the entities associated with the respective one of the attributes. For example, the values of the node 804-1 lead to the intention candidates 806-1, 806-2 and 806-3. Specifically, the value “Shanghai” of the node 804-1 leads to the intention candidate 806-1 (also shown as Intention 1), the value “Xi'an” of the node 804-1 leads to the intention candidate 806-2 (also shown as Intention 2), and the value “Beijing” of the node 804-1 leads to the intention candidate 806-3 (also shown as Intention 3). The value “Beijing” of the node 804-2 leads to the intention candidate 806-4 (also shown as Intention 4) and the value “Shanghai” of the node 804-2 leads to the intention candidate 806-5 (also shown as Intention 5).

Each of the nodes in the decision tree may correspond to a question for interaction with the user. For example, the root node 802 may correspond to a question “which funding?” For example, the nodes 804 may correspond to a question “which city?” The method 400 may determine the user's intention based on the question(s) for interaction with the user, and then determine the answer to the user's question. Returning to FIG. 4, at block 408, the method 400 may generate a question corresponding to a node of the decision tree to determine the user's intention. For example, a question may be generated corresponding to the root node of the decision tree. As shown in FIG. 8, the question corresponding to the root node 802 may be “which funding?” The question may alternatively include some choices for the user. For example, the question may be “Housing fund or pension?”

At block 410, the method 400 may receive the user's answer to the generated question from the client computing device. For example, the method 400 may provide the generated question to the user and then the user may answer the question in response. For example, the user may answer “pension”.

At block 412, the method 400 may determine the user's intention from the decision tree based on the user's answer to the question. For example, if the user's answer is “pension,” the user in effect selects the second subset of the decision tree 800 by answering the question. If the root node 802 is also a leaf node, the user's intention may be determined to be the intention candidate selected by the user's answer. In FIG. 8, the root node 802 is not a leaf node but has two child nodes. In this example, a child node of the root node 802 may be determined based on the user's answer. For example, if the user's answer is “pension”, the child node of the root node 802 is determined to be the node 804-2. Another question may be generated corresponding to the node 804-2, for example, “which city?” For example, if the user's answer to this question is “Beijing”, the candidate intention 806-4 may be determined to be the user's intention, considering that the node 804-2 is a leaf node of the decision tree. If the node 804-2 is not a leaf node but has one or more child nodes, the answer “Beijing” may lead to a child node of the node 804-2 and a further question may be generated corresponding to that child node. Further interactions with the user may be needed to determine the user's intention.

The decision tree 800 has a depth of two, as shown in FIG. 8. It is noted that the decision tree in another embodiment may have a different depth than the decision tree 800. For example, the decision tree may have a depth of one, i.e., the decision tree includes the root node only. The decision tree may alternatively have a depth of more than two. The recall intention candidates may include only highly relevant intention candidates. Hence, the recall intention candidates may include only a small number of intention candidates. By ranking the small number of recall intention candidates, the decision tree may not be too deep, for example, less than three. For example, the depth of the decision tree may be less than three for most cases and no more than two questions are provided to the user. Moreover, the questions may be multiple-choice questions to relieve the user's burden. QA accuracy may be improved without causing any substantial burden for the user.

At block 414, the method 400 may determine a response to the user's question based on the user's intention. For example, if the candidate intention 806-4 may be determined to be the user's intention, it can be determined that the user intends to ask a question “How to withdraw pension in Beijing?”. The method 400 may then query a database for storing question-answer pairs to search for an answer to the disambiguated question. In this way, the method 400 may disambiguate the user's question that may be considered ambiguous and provide a more accurate response to the user. The determined response based on the user's intention is transmitted to the user.

It should be noted that the processing of conducting a natural language dialogue according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A computer-implemented method for conducting a natural language dialogue between a dialogue system and a user of a client computing device, comprising:
receiving, by the one or more processing units, a user question from a client computing device;
determining, by one or more processing units, a plurality of intention candidates of the user from the user's question;
determining, by one or more processing units, a set of entities and attributes associated with the set of entities from the plurality of intention candidates;
constructing, by one or more processing units, a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes;
generating, by one or more processing units, a question corresponding to a node of the decision tree to determine the user's intention;
transmitting, by the one or more processing units, the question to the client computing device;
receiving, by one or more processing units, the user's answer to the question from the client computing device;
determining, by one or more processing units, the user's intention from the decision tree based on the user's answer to the question; and
determining and transmitting, by one or more processing units, a response to the user's question based on the user's intention.

2. The method of claim 1, wherein determining the plurality of intention candidates of the user comprises:
determining, by one or more processing units, at least one intention candidate by each of a plurality of models; and
aggregating, by one or more processing units, the at least one intention candidate to obtain a group of intention candidates; and
deduplicating, by one or more processing units, the group of intention candidates to obtain the plurality of intention candidates.

3. The method of claim 1, wherein the user's question is ambiguous with respect to identifying the user's intention.

4. The method of claim 1, further comprising:
receiving, by one or more processing units, the user's answer to the question; and
determining, by one or more processing units, the user's intention based on the user's answer to the question.

5. The method of claim 1, wherein determining the user's intention from the decision tree based on the user's answer to the question comprises:
in response to the node being a leaf node referencing at least one of the plurality of intention candidates, selecting, by one or more processing units, an intention candidate from the referenced at least one intention candidate corresponding to the user's answer to the question as the user's intention.

6. The method of claim 1, wherein determining the user's intention from the decision tree based on the user's answer to the question comprises:
in response to the node not being a leaf node, determining, by one or more processing units, a child node of the node based on the user's answer to the question; and
generating, by one or more processing units, a subsequent question corresponding to the child node;
receiving, by one or more processing units, the user's answer to the subsequent question; and
determining, by one or more processing units, the user's intention based on the user's answer to the subsequent question.

7. The method of claim 1, wherein generating the question corresponding to the node of decision tree comprises:
generating, by one or more processing units, the question corresponding to a root node of the decision tree.

8. A device comprising:
a processor; and
a memory having instructions stored thereon for execution by the processor, the instructions, when executed by the processor, cause the device to perform acts for conducting a natural language dialogue between a dialogue system and a user of a client computing device, the acts comprising:
receiving a user question from a client computing device;
determining a plurality of intention candidates of a user from the user's question;
determining a set of entities and attributes associated with the set of entities from the plurality of intention candidates;
constructing a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes;
generating a question corresponding to a node of the decision tree to determine the user's intention;
transmitting the question to the client computing device;
receiving the user's answer to the question from the client computing device;
determining the user's intention from the decision tree based on the user's answer to the question; and
determining and transmitting a response to the user's question based on the user's intention.

9. The device of claim 8, wherein determining the plurality of intention candidates of the user comprises:
determining at least one intention candidate by each of a plurality of models; and
aggregating the at least one intention candidate to obtain a group of intention candidates; and
deduplicating the group of intention candidates to obtain the plurality of intention candidates.

10. The device of claim 8, wherein constructing the decision tree comprises:
determining information metrics of the attributes associated with the set of entities; and
constructing the decision tree from top to bottom based on the information metrics of the attributes.

11. The device of claim 8, wherein the user's question is ambiguous with respect to identifying the user's intention.

12. The device of claim 8, wherein determining the user's intention from the decision tree based on the user's answer to the question comprises:
in response to the node being a leaf node referencing at least one of the plurality of intention candidates, selecting an intention candidate from the referenced at least one intention candidate corresponding to the user's answer to the question as the user's intention.

13. The device of claim 8, wherein determining the user's intention from the decision tree based on the user's answer to the question comprises:
in response to the node not being a leaf node, determining a child node of the node based on the user's answer to the question; and
generating a subsequent question corresponding to the child node;
receiving the user's answer to the subsequent question; and
determining the user's intention based on the user's answer to the subsequent question.

14. The device of claim 8, wherein generating the question corresponding to the node of decision tree comprises:
generating the question corresponding to a root node of the decision tree.

15. A computer program product being tangibly stored on a non-transitory machine-readable medium and comprising machine-executable instructions, the instructions, when executed on a device, causing the device to perform acts for conducting a natural language dialogue between a dialogue system and a user of a client computing device, the acts comprising:
receiving a user question from a client computing device;
determining a plurality of intention candidates of a user from the user's question;
determining a set of entities and attributes associated with the set of entities from the plurality of intention candidates;
constructing a decision tree from the set of entities and the attributes associated with the set of entities, wherein each node of the decision tree is associated with a respective one of the attributes and represents a respective subset of the plurality of intention candidates, and wherein the respective subset of the plurality of intention candidates are split based on the entities associated with the respective one of the attributes;
generating a question corresponding to a node of the decision tree to determine the user's intention;
transmitting the question to the client computing device;
receiving the user's answer to the question from the client computing device;
determining the user's intention from the decision tree based on the user's answer to the question; and
determining and transmitting a response to the user's question based on the user's intention.

16. The computer program product of claim 15, wherein determining the plurality of intention candidates of the user comprises:
determining at least one intention candidate by each of a plurality of models; and
aggregating the at least one intention candidate to obtain a group of intention candidates; and
deduplicating the group of intention candidates to obtain the plurality of intention candidates.

17. The computer program product of claim 15, wherein constructing the decision tree comprises:
determining information metrics of the attributes associated with the set of entities; and
constructing the decision tree from top to bottom based on the information metrics of the attributes.

18. The computer program product of claim 15, wherein generating the question corresponding to the node of decision tree comprises:
generating the question corresponding to a root node of the decision tree.

19. The computer program product of claim 15, wherein determining the user's intention from the decision tree based on the user's answer to the question comprises:
in response to the node being a leaf node referencing at least one of the plurality of intention candidates, selecting an intention candidate from the referenced at least one intention candidate corresponding to the user's answer to the question as the user's intention.

20. The computer program product of claim 15, wherein determining the user's intention from the decision tree based on the user's answer to the question comprises:
in response to the node not being a leaf node, determining a child node of the node based on the user's answer to the question; and
generating a subsequent question corresponding to the child node;
receiving the user's answer to the subsequent question; and
determining the user's intention based on the user's answer to the subsequent question.
